(19) United States
(12) Patent Application Publication
(10) Pub. No.: US 2021/0279213 A1
(43) Pub. Date: Sep. 9, 2021

(54) INFORMATION MANAGEMENT APPARATUS AND NON-TRANSITORY COMPUTER READABLE MEDIUM

(71) Applicant: FUJIFILM Business Innovation Corp., Tokyo (JP)

(72) Inventor: Yutaka IKEDA, Kanagawa (JP)

(73) Assignee: FUJIFILM Business Innovation Corp., Tokyo (JP)

(21) Appl. No.: 17/033,672

(22) Filed: Sep. 25, 2020

(30) Foreign Application Priority Data
Mar. 9, 2020 (JP) 2020-040307

(51) Int. Cl. G06F 16/21

(52) U.S. Cl. CPC G06F 16/211

(57) ABSTRACT

An information management apparatus includes a processor configured to find degrees of similarity in field information between databases selected from among plural databases in each of which data are stored in accordance with an arrangement of plural pieces of field information indicative of different kinds of data, create a new database from the selected databases on a basis of the found degrees of similarity, the new database having, as plural pieces of field information, first field information, which is obtained by unifying pieces of field information whose degree of similarity is higher than a threshold value, and second field information whose degree of similarity is equal to or lower than the threshold value, set correspondences between field information of each of the selected databases and the field information of the new database, and perform control according to an input setting as to whether to access any of the selected databases or access the new database on a basis of the correspondences in a case where access to any of the selected databases is requested.

### CROSS-REFERENCE TO RELATED APPLICATIONS

This application is based on and claims priority under 35 USC 119 from Japanese Patent Application No. 2020-040307 filed Mar. 9, 2020.

### BACKGROUND

### (i) Technical Field

The present disclosure relates to an information management apparatus and a non-transitory computer readable medium.

### (ii) Related Art

Japanese Unexamined Patent Application Publication No. 2017-211958 discloses a technique related to an application unification device that searches for an installed program when a program is installed and unifies these programs in a case where it is determined that these programs can be unified on the basis of compatibility between the programs.

### SUMMARY

A known application program accesses a database in which data indicated by plural pieces of field information indicative of different kinds are stored in accordance with a predetermined arrangement and reads and writes data from and into the database. Some recent techniques create and use a new application program similar to an existing application program in order to realize an application program that performs processing desired by a user. In this case, the new application program uses a new database different from a database used by the existing application program. Accordingly, the number of new databases increases every time a new application program is created.

Aspects of non-limiting embodiments of the present disclosure relate to an information management apparatus and a non-transitory computer readable medium that can keep an increase in the number of databases smaller than in a case where a database is prepared for each execution body such as a program that reads and writes data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information management apparatus including a processor configured to find degrees of similarity in field information between databases selected from among plural databases in each of which data are stored in accordance with an arrangement of plural pieces of field information indicative of different kinds of data, create a new database from the selected databases on a basis of the found degrees of similarity, the new database having, as plural pieces of field information, first field information, which is obtained by unifying pieces of field information whose degree of similarity is higher than a threshold value, and second field information whose degree of similarity is equal to or lower than the threshold value, set correspondences between field information of each of the selected databases and the field information of the new database, and perform control according to an input setting as to whether to access any of the selected databases or access the new database on a basis of the correspondences in a case where access to any of the selected databases is requested.

### BRIEF DESCRIPTION OF THE DRAWINGS

An exemplary embodiment of the present disclosure will be described in detail based on the following figures, wherein:

FIG. 1 is a diagram illustrating an example of a configuration of an information management system;

FIG. 2 is a diagram illustrating an example of a configuration of a database server;

FIG. 3 is a diagram illustrating an example of a configuration of an administration terminal;

FIG. 4 illustrates an example of a structure of a database;

FIG. 5 illustrates an example of a functional configuration of a database server;

FIG. 6 is a flowchart illustrating an example of unification processing for unifying databases;

FIG. 7 is a flowchart illustrating an example of processing for setting target apps;

FIG. 8 is a flowchart illustrating an example of flow of processing for creating a unified database;

FIG. 9 is an explanatory view concerning calculation of a degree of similarity;

FIG. 10 is a flowchart illustrating an example of flow of processing for calculating a degree of similarity;

FIG. 11 illustrates an example of a structure of a unified database;

FIG. 12 illustrates a modification of field information of a unified database;

FIG. 13 illustrates an example of conversion information;

FIG. 14 is a flowchart illustrating an example of flow of switching support processing, which is one of management processing; and

FIG. 15 is an explanatory view concerning an app similar to a first app.

### DETAILED DESCRIPTION

An exemplary embodiment that realizes a technique of the present disclosure is described in detail below with reference to the drawings. The present exemplary embodiment discusses a case where the technique of the present disclosure is applied to an information management apparatus that manages a system that executes information processing for reading and writing data by using a database. Constituent elements and processes that act and function in identical manners are given identical reference signs throughout all drawings, and repeated description thereof is omitted as appropriate.

The “database” as used herein is a concept encompassing a collection of data stored in accordance with an arrangement of plural pieces of field information indicative of different kinds of data. The “field information” is information on a record registered in a database and is a concept encompassing information indicative of a category such as a group or a genre to which contents of data belong and an item such as a type of data or a name of data. The “kind of data” is a concept indicative of a group of data that are the same in properties, forms, and the like according to a predetermined standard and may correspond, for example, to information indicative of a group or a genre to which contents of data belong.

The “execution body” as used herein is a concept encompassing a software resource such as an application program (hereinafter referred to as an app) that performs predetermined information processing such as reading and writing of data and a hardware resource for performing the information processing of the app in cooperation with the app.

Information for specifying an app is hereinafter referred to as app information. The “app information” is a concept encompassing attribute information indicative of items such as a name of an app, functions of the app, a category into which the app is classified according to the functions of the app, and a database used by the app. The attribute information may include field information of the database.

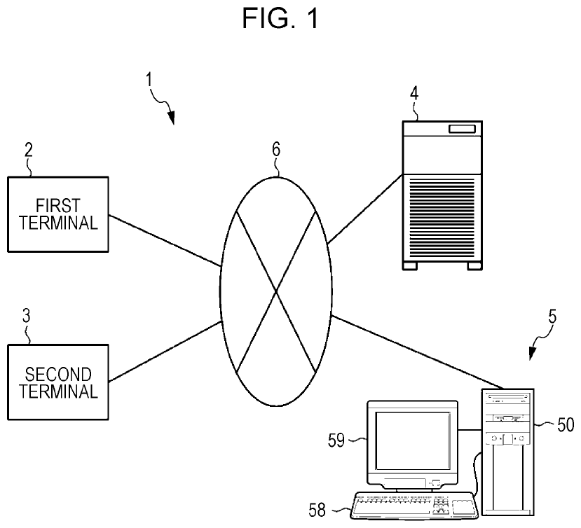

FIG. 1 illustrates an example of a configuration of an information management system 1 according to the present disclosure.

As illustrated in FIG. 1, the information management system 1 includes a first terminal 2 operated by a first user, a second terminal 3 operated by a second user, a database server apparatus 4, and an administration terminal 5 operated by an administrator. Hereinafter, a database is referred to as a “DB”.

The first terminal 2 is a terminal device that gives an instruction to read or write data from or into the DB server apparatus 4 and performs processing for reading or writing data from or into the DB server apparatus 4 in response to an operation made by the first user. Similarly, the second terminal 3 is a terminal device that gives an instruction to read or write data from or into the DB server apparatus 4 and performs processing for reading or writing data from or into the DB server apparatus 4 in response to an operation made by the second user. The first user who operates the first terminal 2 and the second user who operates the second terminal 3 may be the same user or may be different users. The first terminal 2 and the second terminal 3 each may be a computer having a communication function.

The DB server apparatus 4 is an apparatus that performs processing for accumulating a DB and processing for reading and writing data from and into the accumulated DB. The administration terminal 5 is a terminal device that gives an instruction to manage the DB accumulated in the DB server apparatus 4 by the administrator or is a terminal device that gives an instruction to manage the DB accumulated in the DB server apparatus 4 and performs processing for managing the DB accumulated in the DB server apparatus 4 by the administrator. The administration terminal 5 includes a device body 50, an operation input unit 58 such as a keyboard, and a display unit 59 such as a display.

The first terminal 2, the second terminal 3, the DB server apparatus 4, and the administration terminal 5 are connected to one another over a network 6. The network 6 may be at least one of a wireless network and a wired network.

The network 6 is a concept illustrating an example of device-to-device connection and encompasses communication among plural networks such as an intranet or the Internet.

The DB server apparatus 4 is an example of an information management apparatus according to the present disclosure.

### DB Server Apparatus 4

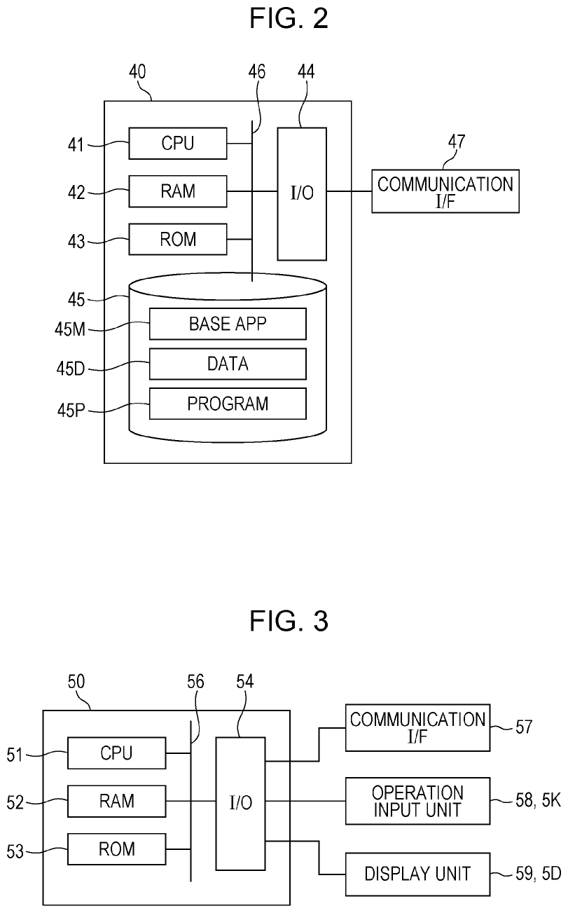

Next, an example of a configuration of the DB server apparatus 4 that can realize the information management apparatus according to the present disclosure is described with reference to FIG. 2.

The DB server apparatus 4 includes a computer body 40, and the computer body 40 includes a central processing unit (CPU) 41, a random access memory (RAM) 42, a read-only memory (ROM) 43, and an input output port (I/O) 44, which are connected to one another through a bus 46. The bus 46 is connected to an auxiliary storage device 45, which can be a hard disk drive (HDD) or a non-volatile flash memory. The I/O 44 is connected to a communication I/F 47 for communication with an external device. Operation display units (omitted in the example of FIG. 2) such as a display, a mouse, and a keyboard are connectable to the I/O 44.

In the auxiliary storage device 45, a base app 45M storing therein plural apps that perform information processing such as reading and writing of data and a utility app for generating and duplicating the plural apps is stored. Furthermore, in the auxiliary storage device 45, various kinds of data 45D including plural DBs used by the plural apps stored in the base app 45M are stored. The plural DBs stored in the auxiliary storage device 45 are an example of DBs managed in the information management apparatus according to the present disclosure.

The plural DBs stored in the auxiliary storage device 45 need not be stored in the DB server apparatus 4. For example, the plural DBs may be stored in an external storage (not illustrated), and the DB server apparatus 4 may read and write data from and into the external storage (not illustrated) through communication.

In the auxiliary storage device 45, a management program 45P for causing the DB server apparatus 4 to function as an information management apparatus is stored. The management program 45P is a program for performing processing for managing DBs. The present exemplary embodiment discusses a case where processing for managing DBs is performed in the DB server apparatus 4.

Specifically, the DB server apparatus 4 performs processing for managing DBs upon receipt of an instruction from the administration terminal 5. That is, the CPU 41 of the DB server apparatus 4 receives an instruction from the administration terminal 5, reads out the management program 45P from the auxiliary storage device 45, loads the management program 45P into the RAM 42, and performs the processing. The DB server apparatus 4 that has executed the management program 45P thus operates as an information management apparatus.

The management program 45P includes processes for executing unification processing and switching processing. Details of these processes will be described later.

Although the present exemplary embodiment discusses a case where the DB server apparatus 4 performs processing for managing DBs upon receipt of an instruction to manage the DBs from the administration terminal 5, the processing for managing the DBs may be performed by the administration terminal 5. Furthermore, the management program 45P may be read out from an external device and a recording medium through the communication I/F 47.

### Administration Terminal 5

Next, an example of a configuration of the administration terminal 5 is described with reference to FIG. 3.

As illustrated in FIG. 3, the administration terminal 5 is a computer that includes a device body 50, and the device body 50 includes a CPU 51, a RAM 52, a ROM 53, and an I/O 54.

The administration terminal 5 includes the device body 50, and the device body 50 includes the CPU 51, the RAM 52, the ROM 53, and the I/O 54, which are connected to one another through a bus 56. The I/O 54 is connected to a communication I/F 57 that communicates with an external device, an operation input unit 58 such as a mouse and a keyboard, and a display unit 59 such as a display. Needless to say, the administration terminal 5 may include an auxiliary storage device (not illustrated).

### First Terminal 2 and Second Terminal 3

The first terminal 2 and the second terminal 3 have a configuration substantially similar to the configuration of the administration terminal 5, and therefore detailed description thereof is omitted. The first terminal 2 and the second terminal 3 may be incorporated into an apparatus that performs data processing therein such as a copying machine, a printer, a facsimile device, a multifunction printer having functions of these devices, a scanner, or a photographic printer. Alternatively, the first terminal 2 and the second terminal 3 each may be an independent computer such as a personal computer (PC) or may be a computer incorporated into a mobile device such as a personal digital assistant (PDA) or a mobile phone.

The management program 45P is an example of a program according to the present disclosure. The DB server apparatus 4 that executes the management program 45P is an example of an information management apparatus according to the present disclosure.

### Management of Databases

Next, management of DBs is described.

It is assumed that an app used for work (e.g., a business app) among plural apps is used by users belonging to a company, users belonging to a department within a company, users belonging to a group within a company, or a single user. In order to make the app used for work meet demands of an individual user or plural users, initial app and DB having various kinds of information used for a standard app such as a structure of an app and settings of a DB that correspond to kind or category of target work are often offered as a base app (template).

Meanwhile, there are cases where individual users attempt to get apps that meet their demands, and as a result, plural apps similar to the base app are generated. In such cases, a DB is generated for each of the plural apps, and the number of DBs increases every time a similar app is generated. This invites an increase in capacity of a device in which the DBs are accumulated and makes management of the apps difficult.

In view of this, in the present exemplary embodiment, the plural DBs generated for the similar apps are unified so that the DBs can be managed.

For simplification of the following description, it is assumed below that plural users within a company, for example, users belonging to different departments use apps for identical or similar work. Furthermore, the following description uses work involving creation of a contract as target work and uses apps and DBs related to a contract as an example.

The following describes, as an example of the apps related to a contract, a first app 410 for creating a contract by using a first DB 414 and a second app 420 for managing a contract by using a second DB 424.

A DB is a collection of plural pieces of data, for each of which information on a category indicative of a group or a genre to which contents of the data and an item such as a type of the data or a name of the data is set by an app. A region of data stored in the DB is a field, and information set in the field is field information. For example, the field information is a set of “label” indicative of a group or a category of stored data and type of the stored data.

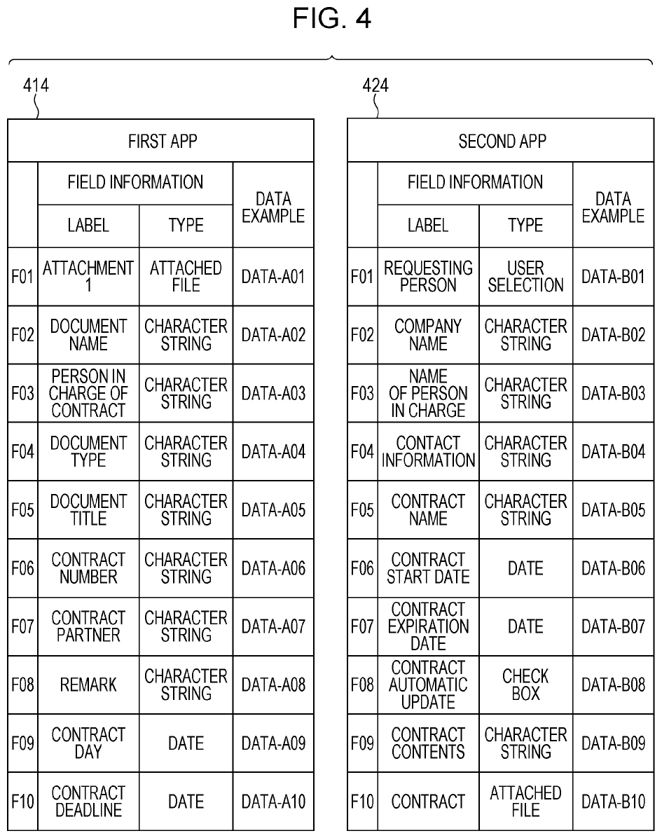

FIG. 4 illustrates an example of the first DB 414 used by the first app 410 (app A) for creating a contract and the second DB 424 used by the second app 420 (app B) for managing a contract.

As illustrated in FIG. 4, field information of the first DB 414 used by the first app 410 is made up of a first field F01 to a tenth field F10. For example, the first field F01 has a label “ATTACHMENT1” and a type “ATTACHED FILE”. Field information of the second DB 424 used by the second app 420 is made up of a first field F01 to a tenth field F10. For example, the first field F01 has a label “REQUESTING PERSON” and a type “USER SELECTION”.

For example, the number of DBs increases in a case where plural similar apps are generated by individual users. In view of this, in the present exemplary embodiment, the plural DBs generated by the similar apps are unified so that the plural DBs can be managed.

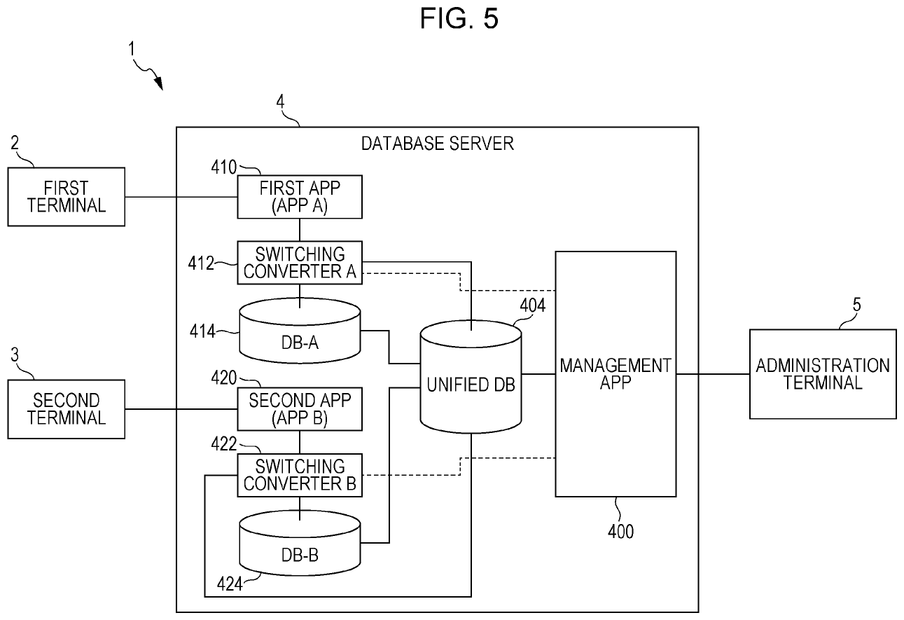

FIG. 5 illustrates an example of a functional configuration of the DB server apparatus 4 that can realize the information management apparatus according to the present disclosure.

As illustrated in FIG. 5, the DB server apparatus 4 includes, an execution body, the first app 410 (illustrated as an app A in FIG. 5) that uses the first DB 414 (illustrated as DB-A in FIG. 5) from the first terminal 2. The first app 410 is an app for creating a contract created by the first terminal 2. The DB server apparatus 4 includes the second app 420 (illustrated as an app B in FIG. 5) that uses the second DB 424 (illustrated as DB-B in FIG. 5) from the second terminal 3. The second app 420 is an app created by the second terminal 3 as an app whose target work belongs to a similar category, that is, an app that belongs to a category of creating a contract. Accordingly, the first app 410 and the second app 420 are similar apps.

The DB server apparatus 4 includes a management app 400 for managing accumulated DBs (DBs including the first DB 414 and the second DB 424). The management app 400 has a function of performing unification processing for generating a unified DB 404 by unifying the first DB 414 and the second DB 424. Details of this unification processing will be described later.

Furthermore, the management app 400 has a function of performing switching support processing for supporting switching of DBs used by the first app 410 and the second app 420 from the first DB 414 and the second DB 424 to the unified DB 404. This switching support processing includes switching support for prompting the first user and the second user to switch from the first DB 414 and the second DB 424 to the unified DB 404 and switching support for switching DBs used by the first user and the second user from the first DB 414 and the second DB 424 to the unified DB 404. Details of this switching support processing will be described later.

Accordingly, the DB server apparatus 4 includes, as execution bodies, a switching converter 412 (illustrated as a switching converter A in FIG. 5) and a switching converter 422 (illustrated as a switching converter B in FIG. 5). The switching converter 412 is a functional unit that switches a DB used by the first app 410 to any of the first DB 414 and the unified DB 404. The switching converter 422 is a functional unit that switches a DB used by the second app 420 to any of the second DB 424 and the unified DB 404.

In the present exemplary embodiment, the number of DBs can be kept small while keeping usability of original app and DB by unifying the first DB 414 and the second DB 424.

Next, operation of the information management system 1 is described. In the present exemplary embodiment, management processing performed in the DB server apparatus 4 is described as an example.

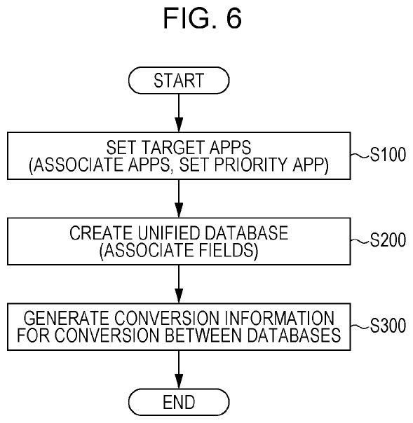

FIG. 6 illustrates unification processing for unifying DBs, which is one of the management processing performed by the DB server apparatus 4. FIG. 6 illustrates an example of flow of unification processing for unifying the first DB 414 and the second DB 424 into the unified DB 404 by the management app 400 (FIG. 5) as a function of the DB server apparatus 4.

When the DB server apparatus 4 receives an instruction from the administration terminal 5 to execute unification processing for unifying DBs among instructions for management of DBs accumulated in the DB server apparatus 4, the CPU 41 performs a unification processing routine illustrated in FIG. 6.

First, in step S100, the CPU 41 sets target apps. Specifically, in step S100, the CPU 41 sets plural (e.g., two) apps that use DBs to be unified. Next, in step S200, the CPU 41 performs processing for unifying the plural DBs. Next, in step S300, the CPU 41 generates conversion information for conversion between the unified DB and the original DBs and then finishes this processing routine.

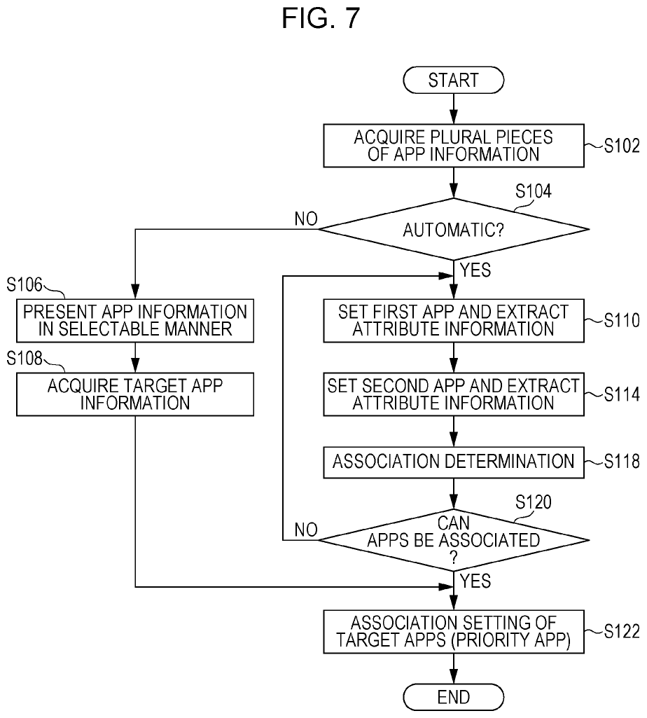

Next, an example of the processing for setting the target apps in step S100 (FIG. 6) is described with reference to FIG. 7.

In step S102, the CPU 41 acquires plural pieces of app information on plural apps to be executed by the DB server apparatus 4. The acquired plural pieces of app information may be app information on all apps to be executed by the DB server apparatus 4 or may be app information on a predetermined number of apps. Furthermore, app information on apps that belong to at least one category may be acquired by using categories included in the app information.

Next, in step S104, the CPU 41 determines whether or not to automatically set the target apps. The determining process in step S104 is performed on the basis of information indicative of an instruction of the administrator. For example, in step S104, the CPU 41 acquires, from the administration terminal 5, instruction information indicative of whether to automatically set the target apps (Yes in step 104) or manually set the target apps.

In a case where the CPU determines in step 104 that the administrator manually sets the target apps (No in step 104), the processing proceeds to step S106. In step S106, the app information on the plural apps acquired in step S102 is transmitted to the administration terminal 5 and is thereby presented to the administrator in a selectable manner.

The administration terminal 5 receives the information from the DB server apparatus 4 and causes the information to be displayed on the display unit 59. The administrator selects plural pieces of app information indicative of the target apps by operating the operation input unit 58. The administration terminal 5 transmits the selected plural pieces of app information to the DB server apparatus 4.

For example, the administrator refers to information indicating that the first app 410 (app A) has a function A (e.g., addition, deletion, and update of a record concerning a contract), information indicating that the first app 410 (app A) uses the DB 414 (DB-A), and field information of the DB 414. Next, the administrator refers to information indicating that the second app 420 (app B) has a function B (e.g., addition, deletion, and update of a record concerning a contract), information indicating that the second app 420 (app B) uses the DB 424 (DB-B), and field information of the DB 424. The administrator sets the first app 410 (app A) and the second app 420 (app B) as two apps to be associated by operating the administration terminal 5.

In step S108, the plural pieces of app information selected by the administrator by operating the administration terminal 5 is acquired from the administration terminal 5, and this processing routine is finished.

Meanwhile, in a case where the CPU 41 determines in step S104 that the target apps are automatically set (Yes in step S104), the processing proceeds to step S110. In step S110, any one of the plural pieces of app information acquired in step S102 is set as a first app, and attribute information is extracted from app information indicative of the first app.

Next, in step S114, the CPU 41 sets a second app different from the first app and extracts attribute information from app information indicative of the second app.

Next, in step S118, the CPU 41 performs association determining processing for determining whether or not to associate the first app and the second app. The association determining processing is processing for determining whether or not to associate the first app and the second app on the basis of at least one of whether names or the apps are similar and whether categories of the apps are identical.

An example of the association determining processing is described below. The CPU 41 extracts attribute information of the first app 410 (app A), for example, attribute information of the function A (information indicating that addition, deletion, and update of a record concerning a contract are available) and extracts attribute information which is field information of the DB 414 (DB-A).

Furthermore, the CPU 41 extracts attribute information (e.g., information indicating that addition, deletion, and update of a record concerning a contract are available) of the second app 420 (app B) and extracts attribute information which is field information of the DB 424 (DB-B). The CPU 41 compares these extracted pieces of attribute information and determines that the first app and the second app can be associated in a case where a degree of similarity is high, specifically, higher than a predetermined threshold value. Note that processing for finding the degree of similarity will be described later.

The CPU 41 may cause the second app 420 (app B) to be executed by using an application programming interface (API) on the basis of a result of extraction of the function A of the first app 410 (app A) and determine whether or not the first app 410 (app A) and the second app 420 (app B) can be associated on the basis of a degree of similarity between results of execution. For example, the CPU 41 extracts attribute information concerning a contract of the function A of the first app 410 (app A). In a case where the attribute information of the function A of the first app 410 (app A) indicates that a document name is “test.pdf” and a person in charge of the contract is “Ikeda”, the second app 420 (app B) is executed by using an API on the basis of the attribute information. Specifically, a record is added by the second app 420 (app B), and information indicating that a field name is a contract name a value thereof is test.pdf and information indicating that a field name is a name of a person in charge and a value thereof is Ikeda is extracted as attribute information of the second app 420 (app B). Since the values of these pieces of attribute information match, it is determined that the degree of similarity is high.

Next, in step S120, the CPU 41 determines whether or not the first app set in step S110 and the second app set in step S114 can be associated by using the result of the association determining processing. In a case where it is determined, as a result of the association determining processing, that the first app and the second app cannot be associated, the processing returns to step S110, and the above processes are performed on other apps.

The association determining processing may be processing for finding degrees of similarity of the first app with all of other apps and associate the first app and an app that has a highest degree of similarity with the first app. In this case, plural sets of apps to be associated can be found by sequentially designating the first app.

Meanwhile, in a case of Yes in step S120, the processing proceeds to step S122, in which the CPU 41 sets the first app and the second app as apps to be associated. Furthermore, in step S122, the first app or the second app can be set as a priority app.

After step S122, this processing routine is finished.

Next, an example of the processing for creating a unified DB in step S200 (FIG. 6) is described.

In the processing for creating the unified DB, matching processing is performed in which pieces of field information of the DB used by the first app 410 set as a priority app are compared one by one with each of pieces of field information of the DB used by the second app 420. In this matching processing, degrees of similarity between pieces of field information are found. Then, unified pieces of field information are determined by using degrees of similarity obtained as a result of the matching processing. For example, a set of pieces of field information whose degree of similarity is higher than a predetermined threshold value is set as a unified field. Specifically, field information of fields that match each other is determined as unified field information using, as a label of a unified field, a label of the first DB 414, a label of the second DB 424, or a label designated, for example, by the administrator and using, as a type of the unified field, a type of the first DB 414, a type of the second DB 424, or a type designated, for example, by the administrator. Then, a unified DB is created by combining field information of the unified field thus determined and field information of the other fields.

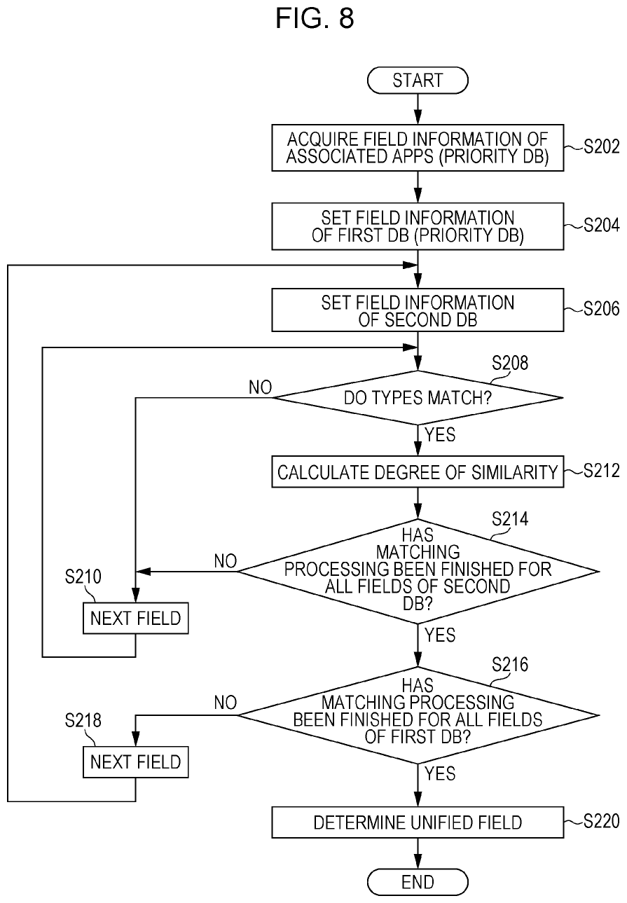

FIG. 8 illustrates an example of flow of the processing for creating the unified DB in step S200 (FIG. 6).

In step S202, the CPU 41 acquires attribute information of the first app 410 (app A) and attribute information of the second app 420 (app B). In this example, the CPU 41 acquires field information of the first DB 414 and field information of the second DB 424.

Next, in step S204, the CPU 41 sets any one of the pieces of field information of the first DB. Next, in step S206, the CPU 41 sets any one of the pieces of field information of the second DB.

Next, in step S208, it is determined whether or not types of the set pieces of field information match each other. In a case where the types do not match each other, step S210 is performed, in which other fields are set. Then, the processing returns to step S208.

In a case of Yes in step S208, the CPU 41 calculates a degree of similarity between the pieces of field information in step S212. The degree of similarity becomes higher as similarity between the field information set in step S204 and the field information set in step S206 becomes higher. The degree of similarity can be calculated by comparing results of natural language analysis on labels of the pieces of field information whose types match each other. Calculation of the degree of similarity will be described later.

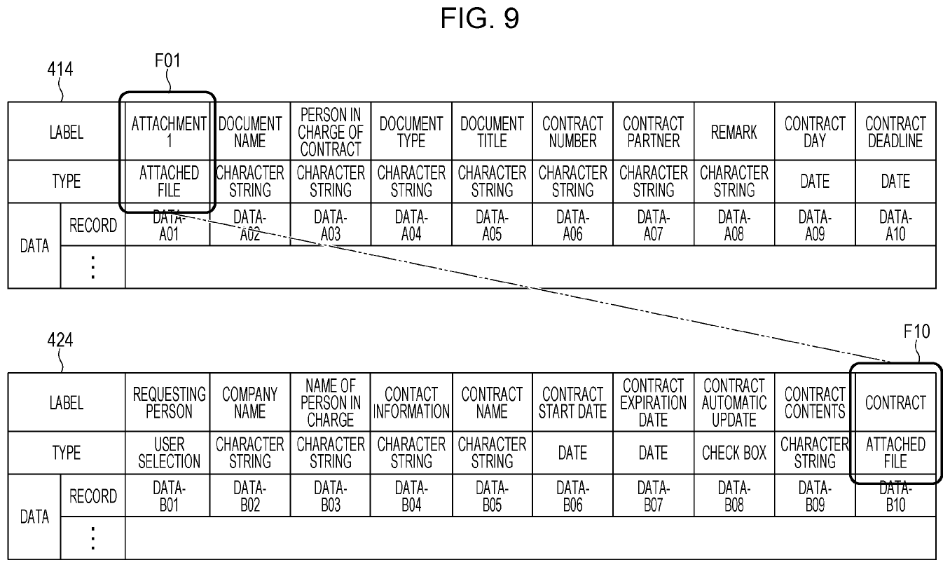

For example, as illustrated in FIG. 9, a degree of similarity between first field information F01 of the first DB 414 and tenth field information F10 whose type matches the type of the first field information F01 of the first DB 414 among the pieces of field information of the second DB 424 is calculated.

Next, in step S214, the CPU 41 determines whether or not the matching processing has been finished for all of the pieces of field information of the second DB 424 used by the second app 420. In a case of No in step S214, step S210 is performed, in which a remaining piece of field information (next field) of the second DB 424 is set. Then, the processing returns to step S208.

Meanwhile, in a case of Yes in step S214, the processing proceeds to step S216, in which it is determined whether or not the matching processing has been finished for all of the pieces of field information of the first DB 414 used by the first app 410. In a case of No in step S216, the step S218 is performed, in which a remaining piece of field information (next field) of the first DB 414 is set. Then, the processing returns to step S206.

In a case where the matching processing has been finished for all of the pieces of field information of the first DB 414 and all of the pieces of field information of the second DB 424, the CPU 41 determines, as a unified field, for example, a set of field information whose degree of similarity is higher than a predetermined threshold value (e.g., a degree of similarity 90) on the basis of the degrees of similarity in step S220. Next, in step S220, the CPU 41 creates a unified DB by combining field information of the unified field thus determined and field information of fields that have not been set as a unified field.

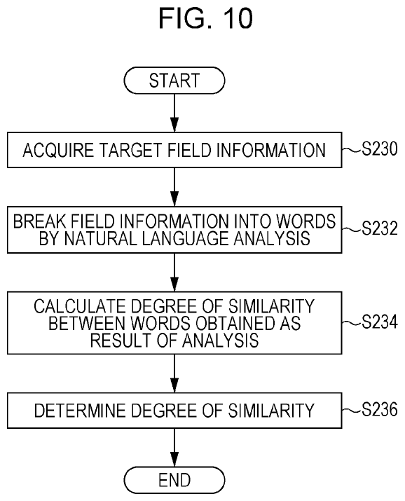

Next, processing for calculating a degree of similarity is described with reference to FIG. 10. The following discusses an example in which a degree of similarity between field information of a tenth field F10 of the first DB 414 and field information of a seventh field F07 of the second DB 424 is calculated.

In step S230, the CPU 41 acquires target field information, that is, field information of the first DB 414 and field information of the second DB 424. In step S230, for example, a degree of similarity between field information of the tenth field F10 of the first DB 414, that is a label “CONTRACT DEADLINE” whose type is a date, and a label “CONTRACT EXPIRATION DATE” of field information of the seventh field F07 of the second DB 424 is calculated.

Next, in step S232, the CPU 41 performs structural analysis on the labels of the field information. In step S232, the label “CONTRACT DEADLINE” of the field information of the first DB 414 is broken down into a word “CONTRACT” and a word “DEADLINE” by natural language analysis. Furthermore, the label “CONTRACT EXPIRATION DATE” of the field information of the second DB 424 is broken down into a word “CONTRACT”, “EXPIRATION”, and “DATE” by natural language analysis.

Next, in step S234, the CPU 41 calculates a degree of similarity between words obtained as a result of the natural language analysis. Calculation of a degree of similarity between words is a known technique, and therefore detailed description thereof is omitted. For example, a known technique such as a technique of calculating a degree of similarity on the basis of a distance between words in a dictionary of synonyms and a word vector can be used. For example, a degree of similarity between the word “DEADLINE” of the label A and the word “CONTRACT” of the label B is calculated as 36, a degree of similarity between the word “DEADLINE” of the label A and the word “EXPIRATION” of the label B is calculated as 73, and a degree of similarity between the word “DEADLINE” of the label A and the word “DATE” is calculated as 83.

Next, in step S236, the CPU 41 calculates a degree of similarity between the labels of the field information by using the degrees of similarity between words calculated in step S234. Specifically, an average of maximum values of degrees of similarity with the word “CONTRACT” and the word “DEADLINE” is calculated as the degree of similarity. More specifically, a degree of similarity between the word “CONTRACT” of the label A and the word “CONTRACT” of the label B is calculated as 100, and a degree of similarity between the word “DEADLINE” of the label A and the word “DATE” of the label B is calculated as 83. An average 92 of these degrees of similarity is determined as a degree of similarity between the label A and the label B.

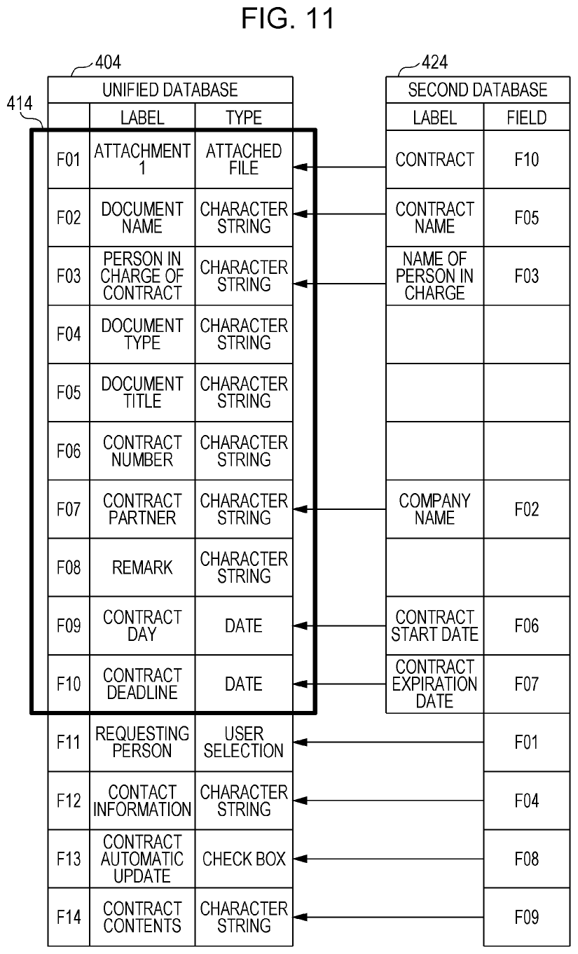

FIG. 11 illustrates an example of the unified DB 404 created by the unification processing.

As illustrated in FIG. 11, the unified DB 404 includes all of the pieces of field information of the first DB 414 since the first DB 414 is given priority. Fields F01, F02, F03, F07, F09, and F10 of the unified DB 404 are unified fields obtained by unifying the first DB 414 and the second DB 424. Meanwhile, fields F11 to F14 of the unified DB 404 are fields other than the unified fields, that is, fields of the second DB 424 whose similarity with the first DB 414 is low (equal to or lower than a threshold value). Accordingly, the unified DB 404 includes both of the field information of the first DB 414 and the field information of the second DB 424 and therefore can be used as at least one of the first DB 414 and the second DB 424.

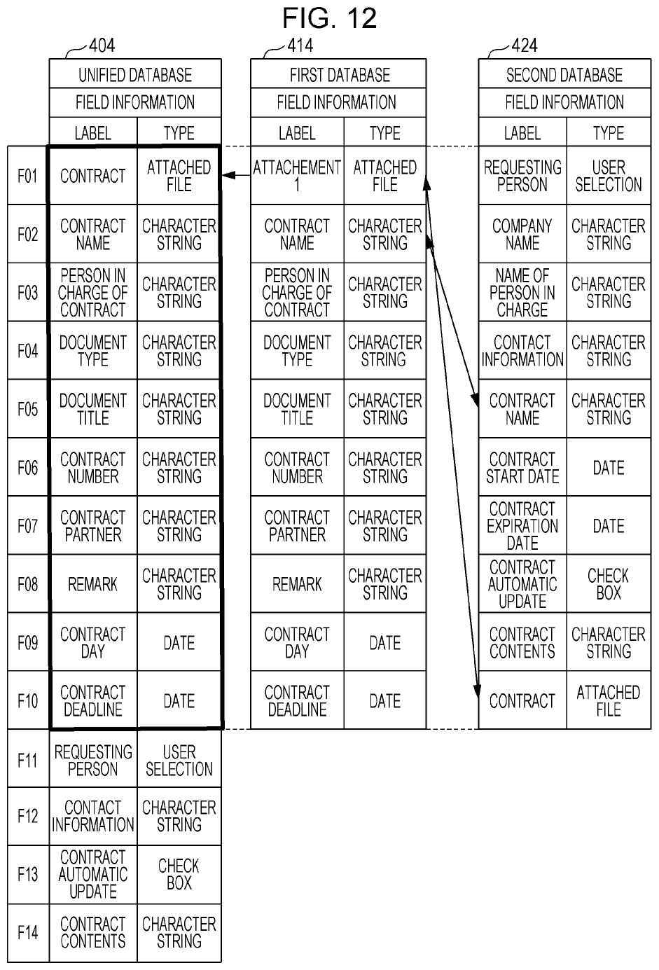

Note that the labels of one of the first DB 414 and the second DB 424 that is set as a priority DB may be used as labels of field information of the unified DB 404, as illustrated in FIG. 11. Alternatively, labels of the first DB 414 or the second DB 424 may be used, as in a modification illustrated in FIG. 12. Alternatively, the labels of field information of the unified DB 404 may be updated, for example, by the administrator.

When the unified DB is created as described above, conversion information for conversion between the unified DB thus created and the original DBs, that is, the first DB 414 and the second DB 424 is generated (step S300 of FIG. 6).

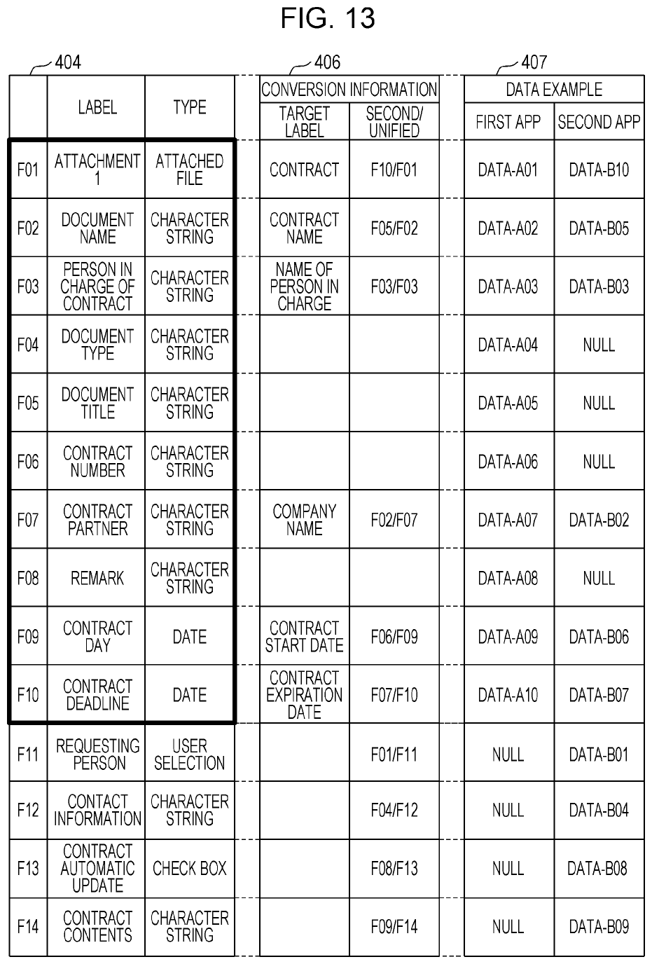

FIG. 13 illustrates conversion information 406 generated in the conversion information generation processing.

As illustrated in FIG. 13, the unified DB 404 is made up of the unified fields including all fields of the first DB 414 and fields other than the unified fields, that is, fields of the second DB 424 whose similarity with the first DB 414 is low (equal to or lower than a threshold value). Accordingly, as for correspondences between the unified DB 404 and the first DB 414, correspondences between field information of the unified DB 404 and field information of the first DB 414 that match each other need just be used as the conversion information 406. Meanwhile, as for correspondences between the unified DB 404 and the second DB 424, correspondences between field information of the unified fields of the unified DB 404 and field information of the second DB 424 unified with the unified fields and correspondences between field information of the unified fields of the unified DB 404 and field information of the second DB 424 other than the unified fields need just be used as the conversion information 406.

Accordingly, in a case where the conversion information 406 is stored in the switching converter 412 and the switching converter 422, the unified DB 404 can be accessed from the first app 410 and the second app 420 by using the stored conversion information 406. In this way, the unified DB 404 can be used as a replacement of the first DB 414 and the second DB 424.

In a case where the first app 410 and the second app 420 use the unified DB 404, fields other than fields used by the first app 410 and the second app 420 need just be made unavailable (data indicated by NULL in FIG. 13) (see a data example 407 in FIG. 13).

Next, switching support processing for supporting switching of DBs used by the first app 410 and the second app 420 from the first DB 414 and the second DB 424 to the unified DB 404 is described. This switching support processing is performed by the management app 400.

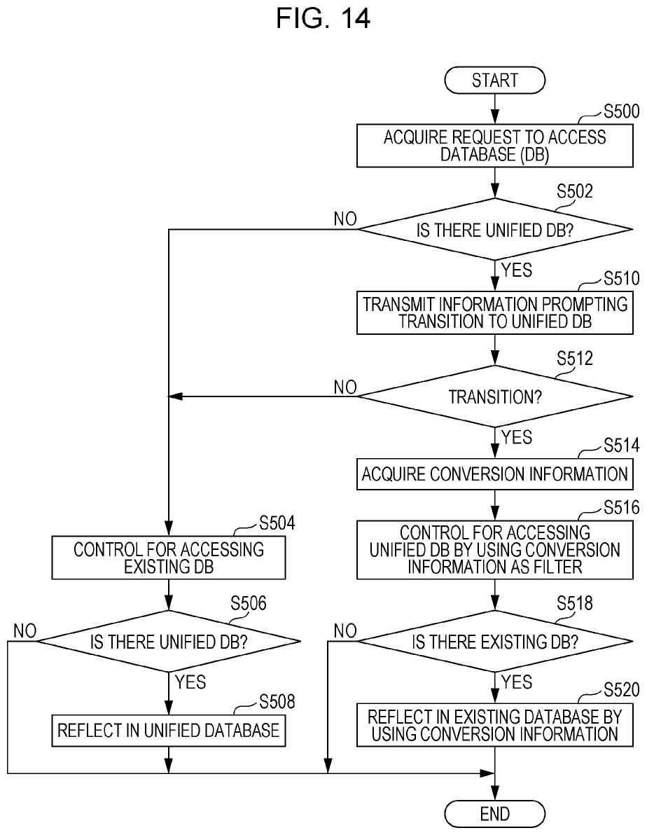

FIG. 14 illustrates an example of flow of the switching support processing, which is one of the management processing performed by the DB server apparatus 4 (by the management app 400). The switching support processing illustrated in FIG. 14 is performed by the CPU 41 regularly or upon occurrence of a request to access a DB.

In step S500, the CPU 41 acquires information indicative of a request to access a DB. Next, in step S502, the CPU 41 determines whether or not there is a unified DB for the DB for which the request has been made. In a case of No in step S502, the processing proceeds to step S504, in which the CPU 41 performs control for accessing the existing DB.

Meanwhile, in a case where there is a unified DB (Yes in step S502), the processing proceeds to step S510, in which the CPU 41 performs information transmission processing for transmitting message information prompting transition from the existing DB to the unified DB 404 to a terminal. For example, in a case where access from the first terminal 2 to the first DB 414 is requested, the CPU 41 transmits message information to the first terminal 2 since the unified DB 404 that covers the field information of the first DB 414 is present. This message information is, for example, information prompting transition to the unified DB such as “You can switch to the unified DB 404 since the unified DB 404 that covers the field information of the first DB 414 is present”.

Next, in step S512, the CPU 41 receives a response from the first terminal 2 and determines whether or not transition to the unified DB 404 has been approved. In a case of No in step S512, the CPU 41 performs control for accessing the existing DB in step S504. Next, in step S506, it is determined whether or not there is a unified DB. In a case of No in step S506, this processing routine is finished. In a case of Yes in step S506, contents of the access control are reflected in the unified DB 404 in step S508. In step 508, processing for reflecting contents (e.g., information such as data update and record addition) of the access to the existing first DB 414 in the unified DB 404 is performed. As a result, contents of the access by the first terminal are reflected in both the first DB 414 and the unified DB 404.

Meanwhile, in a case of Yes in step S512, the CPU 41 acquires the conversion information 406 in step S514. Next, in step S516, the CPU 41 converts field information by using the conversion information 406 as a filter and performs control for accessing the unified DB 404. Next, in step S518, the CPU 41 determines whether or not an existing DB is present (whether or not the first DB 414 is present in this example). In a case of No in step S518, this processing routine is finished. In a case of Yes in step S518, contents of the access control are reflected in the existing first DB 414 in step S520. In step S520, processing for reflecting contents (e.g., information such as data update and record addition) of the access to the unified DB 404 in the first DB 414 is performed. As a result, contents of the access by the first terminal are reflected in both of the first DB 414 and the unified DB 404. The processes in step S518 and step S520 are effective, for example, in a case where the first app 410 is used by plural users and other users want to use the first DB 414.

In the switching support processing illustrated in FIG. 14, a case in which contents of access control to the first DB 414 or the unified DB 404 are reflected in both of the first DB 414 and the unified DB 404 has been described. In this case, access to the first DB 414 becomes unnecessary after completion of transition to the unified DB 404. Accordingly, message information prompting deletion of the first DB 414 may be transmitted after elapse of a predetermined period, and the first DB 414 may be deleted in a case where the deletion is approved. The number of DBs can be reduced by performing this processing.

As described above, in the present exemplary embodiment, similar plural DBs used by plural apps are unified. This makes it possible to suppress an increase in the number of similar DBs used by similar apps, thereby making management of the DBs easy.

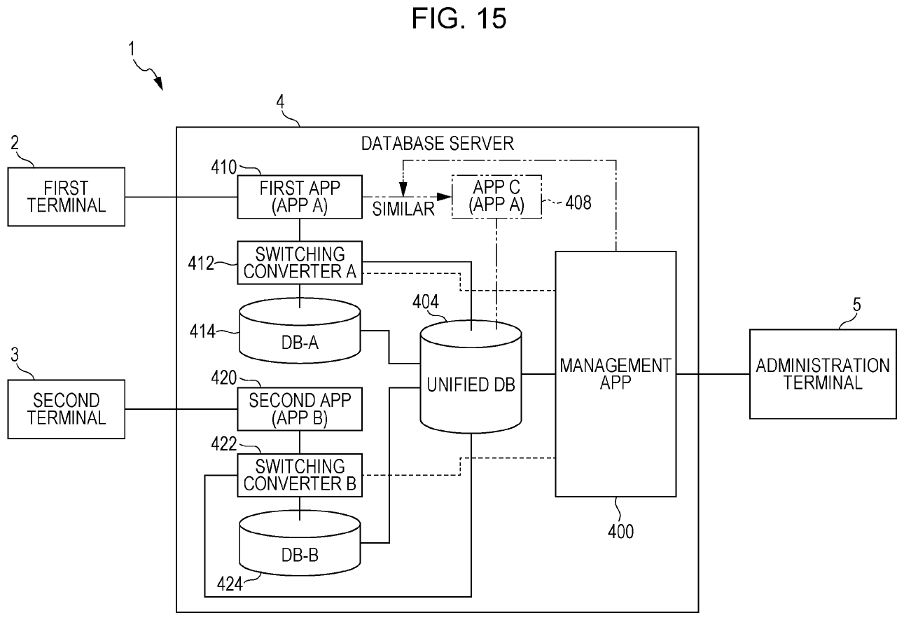

The unified DB 404 created by the DB server apparatus 4 of the information management system 1 can be, for example, grasped as a DB used by an app similar to the first app 410. In view of this, an app 408 (app C) obtained by replacing the field information of the first app 410 with the field information of the unified DB 404 can be generated and offered to a user as a base app (template), as illustrated in FIG. 15. As a result, the unified DB 404 can be accessed without the switching converter 412, and a processing load on the DB server apparatus 4 of the information management system 1 can be lessened.

Although the technique of the present disclosure has been described in detail above by using a specific exemplary embodiment, the technique of the present disclosure is not limited to the exemplary embodiment, and other various exemplary embodiments can be employed within the technical scope of the present disclosure.

Although processing performed by execution of a program stored in an auxiliary storage device has been described in the above exemplary embodiment, the processing of the program may be realized by hardware.

Furthermore, the processing according to the exemplary embodiment may be stored as a program in a storage medium such as an optical disk, and the storage medium may be distributed.

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information management apparatus comprising
a processor configured to
find degrees of similarity in field information between databases selected from among a plurality of databases in each of which data are stored in accordance with an arrangement of a plurality of pieces of field information indicative of different kinds of data,
create a new database from the selected databases on a basis of the found degrees of similarity, the new database having, as a plurality of pieces of field information, first field information, which is obtained by unifying pieces of field information whose degree of similarity is higher than a threshold value, and second field information whose degree of similarity is equal to or lower than the threshold value,
set correspondences between field information of each of the selected databases and the field information of the new database, and
perform control according to an input setting as to whether to access any of the selected databases or access the new database on a basis of the correspondences in a case where access to any of the selected databases is requested.

2. The information management apparatus according to claim 1, wherein
each of the plurality of databases stores therein a plurality of pieces of data used by a plurality of execution bodies that execute different functions.

3. The information management apparatus according to claim 2, wherein the processor is configured to
when performing control to access the new database is performed, perform control for replacing field information of the database for which the access has been requested with the field information of the new database on a basis of the correspondences.

4. The information management apparatus according to claim 2, wherein the processor is configured to
in a case where control for accessing any of the plurality of selected databases is performed, transmit message information prompting access to the new database to an execution body that uses the any of the plurality of selected databases.

5. The information management apparatus according to claim 2, wherein the processor is configured to
in a case where control for accessing the new database is performed, transmit message information indicative of switching from access to any of the plurality of selected databases to the new database to an execution body that uses the any of the plurality of selected databases.

6. The information management apparatus according to claim 3, wherein the processor is configured to
in a case where control for accessing the new database is performed, transmit message information indicative of switching from access to any of the plurality of selected databases to the new database to an execution body that uses the any of the plurality of selected databases.

7. A non-transitory computer readable medium storing a program causing a computer to execute a process for information management, the process comprising:
finding degrees of similarity in field information between databases selected from among a plurality of databases in each of which data are stored in accordance with an arrangement of a plurality of pieces of field information indicative of different kinds of data,
creating a new database from the selected databases on a basis of the found degrees of similarity, the new database having, as a plurality of pieces of field information, first field information, which is obtained by unifying pieces of field information whose degree of similarity is higher than a threshold value, and second field information whose degree of similarity is equal to or lower than the threshold value,
setting correspondences between field information of each of the selected databases and the field information of the new database, and
performing control according to an input setting as to whether to access any of the selected databases or access the new database on a basis of the correspondences in a case where access to any of the selected databases is requested.

8. An information management apparatus comprising:
means for finding degrees of similarity in field information between databases selected from among a plurality of databases in each of which data are stored in accordance with an arrangement of a plurality of pieces of field information indicative of different kinds of data,
means for creating a new database from the selected databases on a basis of the found degrees of similarity, the new database having, as a plurality of pieces of field information, first field information, which is obtained by unifying pieces of field information whose degree of similarity is higher than a threshold value, and second field information whose degree of similarity is equal to or lower than the threshold value,
means for setting correspondences between field information of each of the selected databases and the field information of the new database, and
means for performing control according to an input setting as to whether to access any of the selected databases or access the new database on a basis of the correspondences in a case where access to any of the selected databases is requested.
